(19) United States
(12) Patent Application Publication
(10) Pub. No.: US 2023/0153905 A1
(43) Pub. Date: May 18, 2023

(54) COMPUTER-BASED SYSTEMS AND METHODS CONFIGURED FOR CRYPTOGRAPHIC EVENT COORDINATION

(71) Applicant: EM.ME US, Inc., Delray Beach, FL (US)

(72) Inventors: Maxwell Sanchez, Delray Beach, FL (US); Justin Fisher, Delray Beach, FL (US); Matthew Roszak, Delray Beach, FL (US); Jeff Garzik, Delray Beach, FL (US)

(73) Assignee: EM.ME US, Inc., Delray Beach, FL (US)

(21) Appl. No.: 17/989,020

(22) Filed: Nov. 17, 2022

Related U.S. Application Data
(60) Provisional application No. 63/280,374, filed on Nov. 17, 2021.

(51) Int. Cl. G06Q 40/04; H04L 9/08

(52) U.S. Cl. CPC G06Q 40/04; H04L 9/0869; G06Q 2220/00

(57) ABSTRACT

Systems and methods of present disclosure enable improved security and verifiability of event coordination by receiving an event receiver request requesting an event for a transfer of data between a first user and a second user. The event receiver request includes a first seed value generated by a first random number generator. An event provider request for providing the event is also received, with the event provider request including a second seed value generated by a second random number generator. An event seed value is generated based on a combination of the first seed value and the second seed value, a pseudorandom number generator is used to generate, based on the event seed value, output values defining parameters of the event. The parameters of the event are stored in an event entry of an event log and the transfer of data is executed.

### FIELD OF TECHNOLOGY

The present disclosure generally relates to computer-based systems and methods configured for cryptographic event coordination, including cryptographically determined parameters to generate events, and the verification that events prescribed by the cryptographically determined parameters were successfully executed.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-6 show one or more schematic flow diagrams, certain computer-based architectures, and/or screenshots of various specialized graphical user interfaces which are illustrative of some exemplary aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

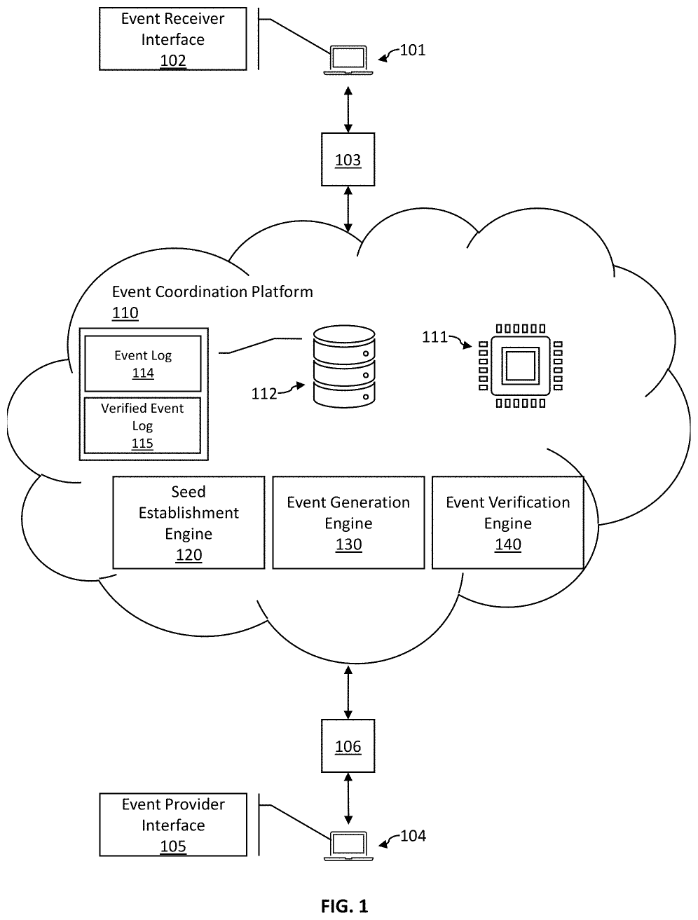

FIGS. 1 through 6 illustrate systems and methods of coordinating events between users on an electronic communication platform using cryptographic seeding for verifiable but private messaging events. The following embodiments provide technical solutions and technical improvements that overcome technical problems, drawbacks and/or deficiencies in the technical fields involving executing exchanges of data between users on electronic communication platforms. As explained in more detail, below, technical solutions and technical improvements herein include aspects of improved event privacy and security while enabling public verifiability, thus improving the security and privacy of the electronic communication platform for the purposes of exchange of private information in a manner which later enables public verifiability of a process, the execution of which can be later verified by a third party with access to the (formerly) private information. Based on such technical features, further technical benefits become available to users and operators of these systems and methods. Moreover, various practical applications of the disclosed technology are also described, which provide further practical benefits to users and operators that are also new and useful improvements in the art.

FIG. 1 is a block diagram of an exemplary computer-based system for event coordination and verification that maintains the per-instance data privacy of associated users while enabling public verifiability in accordance with one or more embodiments of the present disclosure.

In some embodiments, an event coordination platform 110 matches requesting users and providing users for enabling and facilitating an exchange of data between users having matching parameters. In some embodiments, event generation is the result of matching one or more corresponding data transfer requests and data transfer provisions. Once matched, the providing user creates events (based on a seed established between the requesting user and the providing user with an optional third-party) to produce a data transfer event according to the matching parameters. The event coordination platform 110 may then later verify each event based on the seeds.

In some embodiments, users engaging in events on an electronic communication platform may employ an event coordination platform 110 to enable verification of the request, acknowledgement and execution of one or more events between users. A first user may utilize an event receiver interface 102 of a first user computing device 101 to send an event request 103 to the event coordination platform 110. Similarly, a second user may utilize an event provider interface 105 of a second user computing device 104 to send an event response 106 to the event coordination platform 110. In some embodiments, the event request 103 and the event response 105 may both be associated with an electronic communication between the first user and the second, such as, e.g., a transfer of data, data records, files, digital tokens, virtual currency, streaming of media, among other forms of electronic communication where one user may request the communication and another user may provide the communication. Simply for the purposes of illustration, the event is described herein as being associated with a transfer of digital tokens.

In some embodiments, the event coordination platform 110 may receive the event request 103 and the associated event response 106 to generate and verify an event between the users. In some embodiments, the event coordination platform 110 may be a part of the user computing device 101. Thus, the event coordination platform 110 may include hardware and software components including, e.g., hardware and/or software of the first user computing device 101, hardware and/or software of the second user computing device 104, cloud or server hardware and software, or any suitable combination thereof.

In some embodiments, the event coordination platform 110 may include hardware components such as a processor 111, which may include local or remote processing components. In some embodiments, the processor 111 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 111 may include data-processing capacity provided by the microprocessor. In some embodiments, the microprocessor may include memory, processing, interface resources, controllers, and counters. In some embodiments, the microprocessor may also include one or more programs stored in memory.

Similarly, the event coordination platform 110 may include storage 112, such as one or more local and/or remote data storage solutions such as, e.g., local hard-drive, solid-state drive, flash drive, database or other local data storage solutions or any combination thereof, and/or remote data storage solutions such as a server, mainframe, database or cloud services, distributed database or other suitable data storage solutions or any combination thereof. In some embodiments, the storage 111 may include, e.g., a suitable non-transient computer readable medium such as, e.g., random access memory (RAM), read only memory (ROM), one or more buffers and/or caches, among other memory devices or any combination thereof.

In some embodiments, the storage 112 may include, e.g., a blockchain-based data structure and/or other distributed ledger technology. In some embodiments, the event coordination platform 110 and/or the storage 112 may be configured to interact and/or to store data in one or more private, private-permissioned, and/or permissionless cryptographically-protected, distributed databased such as, without limitation, a blockchain (distributed ledger technology) such as the Bitcoin or Ethereum blockchain. Ethereum (Ethereum Foundation, Zug, Switzerland), and/or other similar distributed data management technologies. For example, as utilized herein, the distributed database(s), such as distributed ledgers ensure the integrity of data by generating a chain of data blocks linked together by cryptographic hashes of the data records in the data blocks. For example, a cryptographic hash of at least a portion of data records within a first block, and, in some cases, combined with a portion of data records in previous blocks is used to generate the block unique identifier for a new digital identity block succeeding the first block. As an update to the data records stored in the one or more data blocks, a new data block is generated containing respective updated data records and linked to a preceding block with a hash authenticating at least a portion of the data records in the preceding block. In other words, the linked blocks form a blockchain that inherently includes a traceable sequence of state transformations that can be used to track the updates to the data records contained therein. The linked blocks (or blockchain) may be distributed among multiple network nodes within a computer network such that each node may maintain a copy of the blockchain. Malicious network nodes attempting to compromise the integrity of the database must recreate (by reproduction of alternative blocks) and distribute (by propagation of said blocks) the blockchain faster (defined as the propagation of blocks which replace otherwise-canonical bocks) than the honest network nodes, which, in most cases, is computationally infeasible (or with regards to alternative consensus protocols, is [otherwise] economically infeasible). In other words, data integrity is guaranteed by the computational or economic infeasibility of producing and propagating an alternate chain. In some embodiments, as utilized herein, a central trust authority for sensor data management may not be needed to vouch for the integrity of the distributed database hosted by multiple nodes in the network.

In some embodiments, the exemplary distributed blockchain-type ledger implementations of the present disclosure with associated devices may be configured to affect transactions involving Bitcoins and other cryptocurrencies into one another and also into (or between) so-called FIAT money or FIAT currency and vice versa.

In some embodiments, the exemplary distributed blockchain-type ledger implementations of the present disclosure with associated devices are configured to utilize smart contracts that are computer processes that facilitate, verify and/or enforce negotiation and/or performance of one or more particular activities among users/parties. For example, an exemplary smart contract may be configured to be partially or fully self-executing and/or self-enforcing. In some embodiments, the exemplary inventive asset-tokenized distributed blockchain-type ledger implementations of the present disclosure may utilize smart contract architecture that can be implemented by replicated asset registries and contract execution using cryptographic hash chains and Byzantine fault tolerant replication. For example, each node in a peer-to-peer network including a blockchain distributed network may act as a title registry and escrow, thereby executing changes of ownership and implementing sets of predetermined rules that govern acceptance of transactions on the network. For example, each node may also check the work of other nodes and in some cases, as noted above, function as miners or validators.

In some embodiments, the event coordination platform 110 may implement computer engines for seed establishment, event generation, event verification among other operations or any suitable combination thereof. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, the term “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation.

In some embodiments, to generate and verify events between the users, the event coordination platform 110 may leverage cryptographic seeds and one or more random, pseudo-random, or algorithmic number generators to generate event parameters based on the seeds, and then verify the correct execution of the event via a replay of the generation of the event parameters with public seeds.

In some embodiments, a seed establishment engine 120 may establish the seed for each user. In some embodiments, the seed establishment engine 120 may include dedicated and/or shared software components, hardware components, or a combination thereof that are located, e.g., in a server of the event coordination platform 110, in a cloud of the event coordination platform 110, on the first user computing device 101, on the second user computing device 104, or any combination thereof. For example, the seed establishment engine 120 may include a dedicated processor and storage, shared processor and/or storage (e.g., the processor 111 and/or storage 112), distributed processing and/or storage (e.g., via the first and second user computing devices 101 and 104 among other hardware nodes, etc.), local processing and/or storage (e.g., on the first user computing device 101 or the second user computing device 102), among other arrangements of processing and storage resources or any suitable combination thereof.

In some embodiments, seed establishment engine 120 may establish a secure seed amongst mutually-untrustful users. For the purposes of this disclosure, “secure” is defined as no user having the ability to influence the final seed in a meaningful/predictable manner. In some embodiments, to enable the use of private seeds, the seed establishment engine 120 may be instantiated on or for the first user computing device 101 to establish a securely generated first seed for the first user for receivable an event. Similarly, the seed establishment engine 120 may instantiated on or for the second user computing device 104 to securely generate a second seed for the second user for a provide side in an event. In some embodiments, the seed establishment engine 120 may instantiated on or for an automated and/or manual coordinator, e.g., including the event coordination platform 110 for a coordinator seed.

In some embodiments, the first seed may include any suitable first seed value that is unique to the event request 103. For example, the first seed may include a randomly generated value using a pseudo-random number generator (PRNG) or other suitable random value generation mechanism. Similarly, the second seed and the coordinator seed may include any suitable second seed value and coordinator seed value, respectively.

Amongst N number of users, each user may generate a large (e.g., 32 bytes, 64 bytes, 128 bytes, or greater) random number and calculate a cryptographic hash (ex: SHA256) of their number. In some embodiments, the cryptographic hash may employ a, e.g., SHA-1 series cryptographic hash function, SHA-2 series cryptographic hash function (SHA-256, SHA-512, SHA-224, SHA-384, etc.), SHA-3 cryptographic hash function, MD5 cryptographic hash function, RIPEMD-160 cryptographic hash function, Whirlpool cryptographic hash function, BLAKE2 cryptographic hash function, BLAKE3 cryptographic hash function, KECCAK-256 hash function, POSEIDON-256 hash function, or any other suitable hash function or any combination thereof.

In some embodiments, SHA-256 is a hashing function which maps an input of arbitrary size to a fixed-length output in an irreversible fashion (it is computationally infeasible to rederive the input given the output), with a random distribution of outputs. SHA-256 as it is used in this disclosure is defined by IETF RFC 4634. SHA-256 may be used in some implementations of the present disclosure (where zero-knowledge efficiency is not required) for providers, receivers, and (optionally) a coordinator to commit to private random numbers, and to generate (for the sake of consistent input size and better manipulation resistance) PRNG seeds for order generation from the committed private random numbers.

KECCAK-256 is a hashing function which, like SHA-256, also maps an input of arbitrary size to a fixed-length output in an irreversible fashion, with a random distribution of outputs. KECCAK-256 as it is used in this disclosure is defined by either the FIPS-102 standard or as used by Ethereum. KECCAK-256 is used in some implementations of the present disclosure for the same purpose that SHA-256 may otherwise be used.

POSEIDON-256 is an algebraic hashing function optimized for zero-knowledge proof systems. Similar to SHA256 it securely maps arbitrary inputs to 256-bit outputs in a deterministic fashion, but the design of the algorithm is optimized for faster verification in zero-knowledge circuits. POSEIDEN-256 as it is used in this disclosure is defined by “POSEIDON: A New Hash Function for Zero-Knowledge Proof Systems”. For an implementation of the present disclosure in a smart contract ecosystem which supports zero-knowledge rollups, SHA-256 (or equivalent with respect to function) is replaced with POSEIDON-256 hashes for random number commitments from providers, receivers, and optionally the event coordination platform 110 itself.

In some embodiments, each user may then share a cryptographic hash of the user's seed (e.g., the first seed, the second seed and/or the coordinator seed). The order in which users generate random numbers and share their hashes does not matter (ex: one user can share the hash before another user generates their number). Once the first user has shared the first seed and/or the cryptographic hash of the first seed, and the second has shared the second seed and/or the cryptographic hash of the second seed, all users agree to the public set of hashes, and reveal their random numbers. All users may verify that the revealed random numbers correspond to the agreed-to hashes, and then the first seed, the second seed and collaborator seed are combined in a pre-agreed fashion (e.g., addition, multiplication, concatenation, etc., using a pre-agreed event if relevant [such as for concatenation]) to create an event seed having an event seed value.

In some embodiments, result of the combining of the first seed value, the second seed value and the coordinator seed value is a random seed generated without external third users which no participant could select, allowing a trustless setup of a random seed. This random seed is then fed into a (pre-agreed-upon) pseudorandom number generator to generate as many random numbers as are required for the event the users are partaking in.

Alternately or in addition, one user can withhold a respective seed value from publication, combine all of the other users authenticated random numbers with their still private random number, execute the deterministic event privately, and later prove correct execution of the game by revealing their random number, at which point all other users can calculate the complete seed and replay the event. For example, the second user may use the first seed value and the coordinator seed value to create the event seed with a private, undisclosed second seed value.

In some embodiments, an event generation engine 130 may use the seed generated from the combination of inputs of each user to deterministically generate event parameters. In some embodiments, the event generation engine 130 may include dedicated and/or shared software components, hardware components, or a combination thereof, that are located, e.g., in a server of the event coordination platform 110, in a cloud of the event coordination platform 110, on the first user computing device 101, on the second user computing device 104, or any combination thereof. For example, the event generation engine 130 may include a dedicated processor and storage, shared processor and/or storage (e.g., the processor 111 and/or storage 112), distributed processing and/or storage (e.g., via the first and second user computing devices 101 and 104 among other hardware nodes, etc.), local processing and/or storage (e.g., on the first user computing device 101 or the second user computing device 104), among other arrangements of processing and storage resources or any suitable combination thereof.

The event generation engine 130 deterministically generates events based on a random number, generated by e.g., a pseudo-random number generation (PRNG) seeded with the combination of inputs of each user, including the seeds generated by the seed establishment engine 120. In some embodiments, events may be generated further based on an event duration, average event length, initial event period, average number of initial events, standard deviation of events from an associated difference between a quantity and/or value and/or total (hereinafter “amount”) of digital assets and/or representation of assets of the event request 103 and an amount of digital tokens of the event response 105 (“spread”), and (optionally) a threshold amount of digital tokens for new events.

In some embodiments, the PRNG may include, e.g., a linear congruential PRNG, a Gaussian random PRNG, or any other suitable PRNG or any combination thereof. A Linear Congruential PRNG deterministically produces a sequence of pseudo-random numbers generated by a piecewise linear equation. A Linear Congruential PRNG can be seeded with a sequence of bits. The same Linear Congruential PRNG implementation seeded with the same seed will always produce the same “random” outputs in the same order, permitting recalculation of “random” numbers given the original input seed. Accordingly, in some embodiments, a Linear Congruential PRNG is used as the PRNG of choice in some implementations of the disclosure to deterministically generate random numbers which are used to generate events a provider is required to place, and (due to determinism) allow later re-generation of said events for verification purposes.

A Gaussian Random PRNG will generate random numbers with an (approximately) gaussian (normal) distribution, given a mean and variance. A Gaussian Random PRNG as it is used in this disclosure is defined by the Java default implementation of the next Gaussian[3] function which approximates a normal distribution, with transformations for different standard deviations (multiplication) and mean (addition). More specifically, the probability density function (PDF) of outputs (approximately) follows the Gaussian Random PRNG:

$$\frac{1}{σ \sqrt{2 π}} {e}^{- \frac{1}{2} {( \frac{x - μ}{σ} )}^{2}} \qquad Equation 1$$

Where σ=standard deviation, μ=mean. Equivalently, this PDF can be used to compute the probability of the value landing between −y*σ+μ and y*σ+μ (for example, if y=2 then we are computing the probability of the value landing within two standard deviations from the mean) as:

$${\int }_{- y σ + μ}^{y σ + μ} \frac{1}{σ \sqrt{2 π}} {e}^{- \frac{1}{2} {( \frac{x - μ}{σ} )}^{2}} dx = erf ( \frac{y}{\sqrt{2}} ) \qquad Equation 2$$

The Gaussian Random PRNG may be used to generate random values for events which fall along a normal distribution from a current value level of the associated digital tokens (for example, approximately 68.27% of event will fall within one (provided) standard deviation from the spread, approximately 95.45% of orders will fall within two (provided) standard deviations from the spread, etc.).

In some embodiments, the seed, securely generated, is used to seed a pre-agreed-upon PRNG algorithm (for example, all users use the same PRNG algorithm, or each combination of receiving user and providing user agree to a particular PRNG algorithm). The receiving user and providing user have already agreed upon a maximum amount of digital tokens and/or other assets for the event, event duration (e.g., in milliseconds, seconds, minutes, hours, days, etc.), an average event length (e.g., in milliseconds, seconds, minutes, hours, days, etc.), an average number of initial events, a length of initial event setup, a standard deviation for spread, which side(s) events will be generated on (receive, provide, both), and a threshold size for new events (these are either agreed to as part of the events, or are constants in the system used globally).

In some embodiments, the event generation engine 130 may generates a set of numbers associated with parameters of an event. The numbers may include an average number of events, a size of an event, among other parameters defining characteristics of the event.

In some embodiments, the event generation engine 130 may receive from the seed establishment engine 120 a random where the random number is determined by the output of 120. For either the receive side, the provide side, or both sides (depending on, e.g., user selection by the first user, the second user or both), the algorithm may generate different value levels, which may, on average, adhere to the normal distribution shaped by the agreed-upon standard deviation from the spread. For example, the algorithm may use a Gaussian Distribution PRNG to generate the value levels.

In some embodiments, for each initial event, the event generation engine 130 may select a size for said event. For example, the event generation engine 130 may use a Gauss Error Function to determine how far from the spread the event is based on the probability of being further away, keeping in mind to not exceed a value associated with the event response 106.

The Gauss Error Function is defined as:

$$erf ( x ) = \frac{2}{\sqrt{π}} {\int }_{0}^{x} {e}^{- {t}^{2}} dt \qquad Equation 3$$

Because it is a non-elementary function, the computation using the series expansion with a suitable number of computation rounds, e.g., 40 computation rounds, both for computational ease and the requirement for exact reproducibility (use 3.14159265 for π, and ensure IEEE 754 floating point calculations are used):

$$erf ( x ) = \frac{2}{\sqrt{π}} {\sum }_{n = 0}^{40} \frac{{( - 1 )}^{n} {x}^{2 n + 1}}{n ! ( 2 n + 1 )} \qquad Equation 4$$

It should be noted that some definitions of erf do not contain the leading factor of 2/√n, and using an implementation based on this definition will not perform properly in the order generation algorithm. In some embodiments, the Gauss Error Function may be used to size events (e.g., according to an amount of digital tokens, a value associated with each digital token, etc.) with a higher distance from the spread larger than those with a lower distance on average.

In some embodiments, the quantities are generated as percentages of the threshold value and later converted to numbers during execution, which allows for the easy scaling in the event of some events being completed or partially completed. A traditional PRNG (like a Linear Congruential PRNG) can be used to assign a start time (falling within the specified length of initial trade setup) and a duration (which on average is the average event length).

In some embodiments, an event verification engine 140 may use the seed from each user to deterministically generate event parameters. In some embodiments, the event verification engine 140 may include dedicated and/or shared software components, hardware components, or a combination thereof, that are located, e.g., in a server of the event coordination platform 110, in a cloud of the event coordination platform 110, on the first user computing device 101, on the second user computing device 104, or any combination thereof. For example, the event verification engine 140 may include a dedicated processor and storage, shared processor and/or storage (e.g., the processor 111 and/or storage 112), distributed processing and/or storage (e.g., via the first and second user computing devices 101 and 104 among other hardware nodes, etc.), local processing and/or storage (e.g., on the first user computing device 101 or the second user computing device 102), among other arrangements of processing and storage resources or any suitable combination thereof.

In some embodiments, the event verification engine 140 may be utilized and/or implemented by the event coordination platform 110, a third-party verifier, the first user, the second user, or any combination therefore. The event verification engine 140 may conduct a simulation phase, where the event verification engine 140 simulates execution of the events and keeps track of the total value below the threshold value available for the generation of events. As the event verification engine 140 completes events, the amount of total event values which is available for use in a new event increases, and once this available total event value exceeds the new event threshold, a new event is generated with a start time after the current latest-starting event of the same type (receive or provide, respectively) and after the current simulation time, optionally with a random additional offset generated from the traditional PRNG and an average offset defined by a global constant or a passed-in argument.

After the simulation phase reaches the end of the specified round duration in milliseconds, it returns the list of events for placement on a verified event log 115. The list of events may only contain the type(s) specified when the process was invoked (receive, provide, or both).

In some embodiments, the event verification engine 140 regenerates events based on instructions from secure seeds generated from one or more third users which is fed into the event generation algorithm. The re-generated events may be compared against historical event data in the event log 114 to verify that the second user successfully placed the prescribed events at the correct times and left the events up for a sufficient duration based on the parameters of the generated events.

The coordinator uses the random seed, such as the combined seed value of the first seed, the second seed and (optionally) the third seed to regenerate events that a particular provider was required to place during an event round and acquires historical event data from the recreation of event log 114. This historical event data from the event log 114 may be acquired from a third-user provider (such as the exchange and/or platform itself, or a data collection service) or can be recorded in real-time during the event round in preparation.

The recorded or otherwise acquired data can be replayed, allowing a view of the historical event data from the event log 114 and recently executed events throughout the period during which digital tokens were to be provided. By looking for the placement of events based on historical event data from the event log 114 which the regenerated list of events specifies, verifying that these events were not taken down until their duration expires unless executed events filled or partially filled the specified digital token-providing events, and keeping track of the remaining tokens available to the provider in the event of fills or partial fills for correctly interpreting future event placement.

### EXAMPLE—CRYPTOGRAPHIC EVENT COORDINATION FOR LIQUIDITY ORDERS

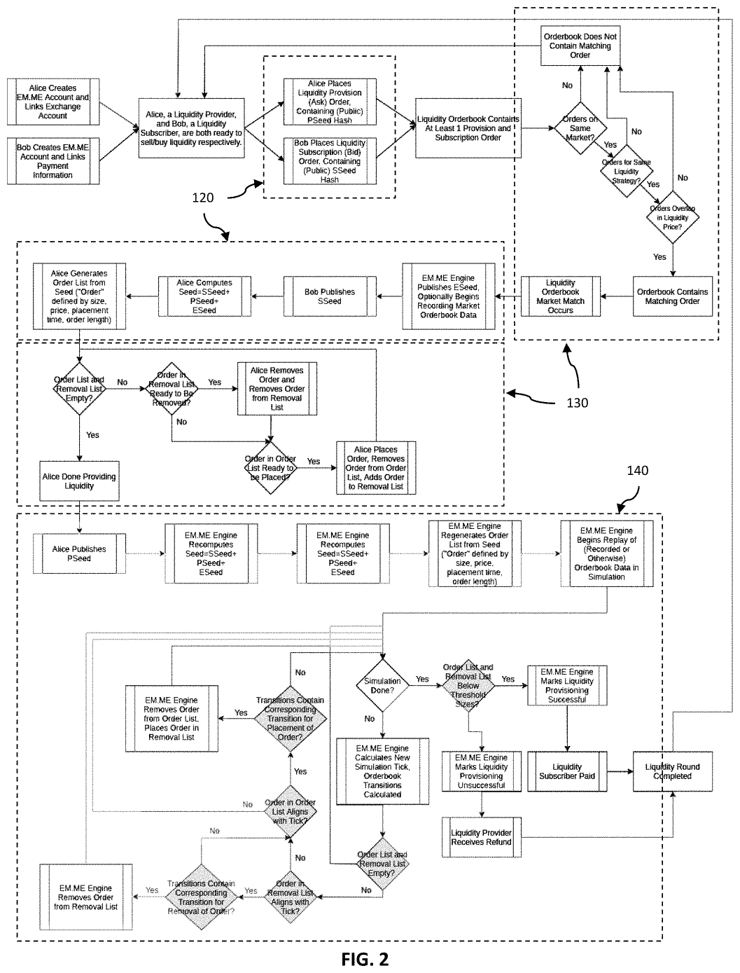

FIG. 2 illustrates a flowchart of an illustrative methodology of cryptographic event coordination for an example event of a liquidity order in accordance with one or more embodiments of the present disclosure.

For the purpose of understanding embodiments of the present disclosure, one version of this broader system may include a front-end interface (e.g., event receiver interface 102, event provider interface 105, or other interface) for a user to create and manage an account, place liquidity subscription (bid) and liquidity provision (ask) orders, match overlapping orders between multiple user accounts (a bid and ask for liquidity that agree on price and order specifics), coordinate between a liquidity provider and liquidity subscriber to generate a secure seed, coordinate the liquidity provider to use the secure seed to generate orders which they place on the orderbook (e.g., the event log 114) as specified by the specifics of the order, coordinate the public reveal of the liquidity provider's secret portion of the cryptographically secure seed, regenerate the orders based on the revealed seed and cross-reference these against recorded or otherwise available market history information, and remit payment to the liquidity provider if orders were placed properly. In some embodiments, the event coordination platform 110 may facilitate a verifiable and publicly auditable environment for liquidity provisioning services on any exchange with an orderbook.

### Secure Cryptographic Seed Establishment

The purpose of this process is to establish (e.g., by the seed establishment engine 120) a secure seed amongst mutually-untrustful parties. For the purposes of this disclosure, “secure” is defined as no party having the ability to influence the final seed in a meaningful/predictable manner.

For example, Alice and Bob want to play a (fair) game together, which is generated from a seed (number). Because particular seeds are known to advantage one party over another, they will only play if they select a seed which neither party can select nor bias. However, they do not trust a third party to provide the seed either, so must somehow construct it amongst themselves. (Generalization: many parties neither trust each other nor any other party, but they all want to play a game using a seed that no party can select or bias.). Alice and Bob both choose a random number, and “seal” it, so neither party can change the chosen number. Both reveal their random numbers, verify the other party's revealed random number corresponds to the seal, and then combine their random numbers to produce the uninfluenceable seed.

In some embodiments, amongst N parties, each party generates a large (ex: 32 bytes) random number and calculates a cryptographic hash (ex: SHA256) of their number and shares this cryptographic hash, or the number itself (depending on the trust requirements of the algorithm). The order in which parties generate random numbers and share their hashes does not matter (ex: one party can share the hash before another party generates their number). Once all parties have shared the hash of their random number, all parties agree to the public set of hashes, and reveal their random numbers. All parties verify the revealed random numbers correspond to the agreed-to hashes, and then the random numbers are combined in a pre-agreed fashion (ex: addition, multiplication, concatenation, etc., using a pre-agreed order if relevant [such as for concatenation]). The result is a random seed generated without external third parties which no participant could select, allowing a trustless setup of a random seed. This random seed is then fed into a (pre-agreed-upon) pseudorandom number generator to generate as many random numbers as are required for the “game” the parties are partaking in. Alternately, one party can withhold their random number from publication, combine all of the other parties' authenticated random numbers with their still private random number, execute the deterministic game privately, and later prove correct execution of the game by revealing their random number, at which point all other parties can calculate the complete seed and replay the game (which is how this process is used in the present disclosure).

### Detailed Implementation Example

No parameters are passed into the secure cryptographic seed establishment process.

Because different parts of the secure cryptographic seed establishment process are performed on different computational systems without access to each other (other than triggering events based on changes they cause to globally available state), this detailed implementation example is split into multiple subprocesses.

Additionally, a globally available state that all parties can write certain values to exists. This can be implemented in many ways: owners of different processes may be identified by a cryptographic identity (ex: a public key or blockchain address) and they may publish to a global state by executing a transaction on the blockchain network, a central server may allow subprocesses run by different parties to write to a global state that they maintain in-memory and inform other subprocesses of changes to global state, etc. This process description is general in that it would operate with any compatible global storage, with notes on different behavior for different types of global storage where applicable. Additionally, some portions of global state may be implicit: for example once a field is set (like a hash is published), another field may be deterministically generated (ex: another field being set to the hash of the block containing the transaction which set the original field).

The global state contains the following fields:

Order Generation Algorithm Parameters

| Field | Type | Description |
|---|---|---|
| liqSubscriberSeed | 32-bit unsigned | Random seed |
| | integer | generated by the |
| | | liquidity subscriber |
| liqProviderSeedHash | 256-bit unsigned | Hash of random seed |
| | integer | generated by liquidity |
| | | provider |
| liqProviderSeed | 32-bit unsigned | Random seed |
| | integer | generated by liquidity |
| | | provider |
| coordSeedHash | 256-bit unsigned | Hash of random seed |
| | integer | generated by |
| | | coordinator |
| coordSeed | 32-bit unsigned | Random seed |
| | integer | generated by |
| | | coordinator |

### Subprocess 1: Liquidity Subscriber Seed Generation and Publication

In some embodiments, the liquidity subscriber seed generator may be run on a computer operated by Liquidity Subscriber, e.g., the first user computing device 101.

### Example Algorithm

1. Seed a Linear Congruential PRNG with a 32-bit seed, which can be selected in any fashion (ex: the current system time mod the number of processes running according to the system kernel, or from entropy provided from the built-in entropy sources of many modern computers), this PRNG is referred to as [symbol]
2. Set a new local 32-bit unsigned integer variable [symbol] to the first 32 bits of data generated by [symbol]
3. Publish [symbol] to the global field [symbol] (ex: through a blockchain transaction, or by sending [symbol] to a central coordinator in a network packet)

### Subprocess 2: Liquidity Provider Seed Generation and Publication

In some embodiments, the liquidity provider seed generator may be run on a computer operated by Liquidity Provider, e.g., the second user computing device 104.

### Example Algorithm

1. Seed a Linear Congruential PRNG with a 32-bit seed, which can be selected in any fashion (ex: the current system time mod the number of processes running according to the system kernel, or from entropy provided from the built-in entropy sources of many modern computers), this PRNG is referred to as [symbol]
2. Set a new local 32-bit unsigned integer variable [symbol] to the first 32 bits of data generated by [symbol]
3. Set a new local 256-bit unsigned integer variable [symbol] to the output of the [symbol] , [symbol] , or [symbol] (depending on specific implementation; ex: whether any validation logic occurs in zk-rollups) of [symbol]
4. Publish [symbol] to the global field [symbol] (ex: through a blockchain transaction, or by sending [symbol] o a central coordinator in a network packet)
5. Wait for signal from external process which indicates that the liquidity round has concluded
6. Publish [symbol] to the global field [symbol] (ex: through a blockchain transaction, or by sending [symbol] to a central coordinator in a network packet)

### Subprocess 3.1: Coordinator Seed Generation and Publication [Non-Smart-Contract]

In some embodiments, the coordinator seed generator may be run on a computer operated by a central coordinator, e.g., another user computing device and/or the event coordination platform 110.

### Example Algorithm

1. Seed a Linear Congruential PRNG with a 32-bit seed, which can be selected in any fashion (ex: the current system time mod the number of processes running according to the system kernel, or from entropy provided from the built-in entropy sources of many modern computers), this PRNG is referred to as [symbol]
2. Set a new local 32-bit unsigned integer variable [symbol] to the first 32 bits of data generated by [symbol]
3. Set a new local 256-bit unsigned integer variable [symbol] to the output of the [symbol] , [symbol] , or [symbol] (depending on specific implementation; ex: whether any validation logic occurs in zk-rollups) of [symbol]
4. Publish [symbol] to the global field [symbol] (ex: through a blockchain transaction, or by sending [symbol] to a central coordinator in a network packet)
5. Wait for signal from external process which matches liquidity orders in a liquidity round, indicating that the match has been completed
6. Publish [symbol] to the global field [symbol] (ex: through a blockchain transaction, or by setting the global state maintained on the Central Coordinator)

### Subprocess 3.2: Coordinator Seed Generation and Publication [Smart-Contract]

In some embodiments, coordinator seed generator, when implemented as a smart contract on a blockchain, may be run on all full-node validators of the blockchain network, e.g., the first user computing device 101, the second user computing device 104 and any other user computing devices and/or servers associated with a blockchain of the event coordination platform 110.

### Example Algorithm

1. Wait for [symbol] to be set in the global state
2. Set [symbol] in the global state to the [symbol] , [symbol] , or [symbol] hash of the concatenation of the [symbol] and the [symbol] of the block containing the blockchain transaction which resulted in [symbol] to be set in the global state

Liquidity subscribers commit to one or more random numbers by publishing their hashes when they place an order. Liquidity providers also commit to one or more random numbers in the same fashion. When a subscription and provision order are matched, the subscriber reveals their private random seed publicly. Optionally, another random number can be sourced (for example, a coordination engine can also commit to a random number and reveal it, or a public randomness utility such as the most recent hash of the Bitcoin blockchain can be used). The liquidity provider combined the revealed secret number of the liquidity subscriber, the optional third-party random number, and their (still secret) random number using concatenation, and the SHA256 hash of the concatenated random numbers is calculated. This SHA256 hash is used as the seed for a shift-register PRNG, which is used in an order generation algorithm (described below) to generate the orders the liquidity provider is required to place on a particular marketplace (type, size, time, duration). The liquidity provider then places the appropriate orders at the appropriate times, removing them once their duration is completed. After the liquidity providing round, the liquidity provider reveals their (still private) random number, allowing any party (the liquidity subscriber, a third-party auditor, etc.) to regenerate the hash of the random number combination, re-calculate all the orders the liquidity provider was required to place, and compare these orders to the actual orderbook activity to verify proper liquidity provisioning activity.

### Order Generation

The order generation algorithm (e.g., by the event generation engine 130) deterministically generates orders (e.g., buy order and/or sell order) based on a PRNG, round duration, average order length, initial order period, average number of initial orders, standard deviation of orders from the bid/ask spread, and a threshold of available liquidity for new order placement.

For example, one party (a liquidity provider) agrees to place orders on an orderbook in exchange for consideration (which for the purposes of this disclosure may be non-existent, but is generally not in practice) from another party (a liquidity subscriber) in a way which adheres to certain pre-defined boundaries (such as how far the orders will fall on average from the bid/ask spread), but in a fashion where neither party can influence the order selection (as if the liquidity provider is honest and using a truly random number). As a result, two mutually distrustful parties can exchange liquidity services in a provably fair fashion with full auditability by a third party with access to the securely generated seed (which in practice is generally public).

In some embodiments, a PRNG (for example, a Linear Congruential PRNG) is seeded with a seed generated in a collaborative fashion. For the purposes of this disclosure, the PRNG is deterministic, returning the same “random” values in the same order when seeded with the same seed. Random values are extracted from the PRNG to establish the geometry of orders created. These random values are used to define the order, size, price, placement time, and duration of orders. As an output of the process, a list of orders is generated which the liquidity provider places at the prescribed times and removes (if not already filled) after the prescribed durations expire.

In some embodiments, the seed securely generated is used to seed a pre-agreed-upon PRNG algorithm (for example, all participants in the system use the same PRNG algorithm, or each combination of liquidity subscriber and liquidity provider agree to a particular PRNG algorithm). The liquidity subscriber and provider have already agreed upon a maximum amount of liquidity, round duration (in milliseconds), an average order length (in milliseconds), the average number of initial trades, the length of initial trade setup, the standard deviation for price placement, which side(s) liquidity orders will be generated on (buy, sell, both), and a threshold size for new orders (these are either agreed to as part of the orders, or are constants in the system used globally).

The process generates a random number which is (on average) the supplied average number of initial trades. For either the buy side, the sell side, or both sides (depending on agreement), the algorithm will generate different price levels (which on average adhere to the normal distribution shaped by the agreed-upon standard deviation from the bid/ask spread, for example using a Gaussian Distribution PRNG), and for each initial order select a size for said order (for example, using the Gauss Error Function to determine how far from the bid-ask spread the order is based on the probability of being further away), keeping in mind to not use more total liquidity than the liquidity provider has agreed to provide. In the recommended implementation, the quantities are generated as percentages of available liquidity and later converted to numbers during execution, which allows for the easy scaling in the event of some liquidity-providing orders being filled or partially filled. A traditional PRNG (like a Linear Congruential PRNG) can be used to assign a start time (falling within the specified length of initial trade setup) and a duration (which on average is the average order length).

The process then moves into the simulation phase, where it simulates execution of the orders and keeps track of the total liquidity available for the generation or orders. As it removes orders, the amount of total liquidity which is available for use in a new order increases, and once this available total liquidity exceeds the new order threshold, a new order is generated with a start time after the current latest-starting order of the same type (buy or sell, respectively) and after the current simulation time (ensuring the liquidity is now usable), optionally with a random additional offset generated from the traditional PRNG and an average offset defined by a global constant or a passed-in argument.

After the simulation phase reaches the end of the specified round duration in milliseconds, it returns the list of orders for placement on the orderbook. The list of orders will only contain the type(s) specified when the process was invoked (buy, sell, or both).

### Detailed Implementation Example

The following parameters are passed into the order generation algorithm:

Order Generation Algorithm Parameters

| Parameter | Type | Description |
|---|---|---|
| seed | 64-bit unsigned | Seed for all |
| | integer | pseudorandom |
| | | number generation |
| roundDurationMS | 32-bit unsigned | Duration of a round |
| | integer | in milliseconds |
| averageOrderLengthMS | 32-bit unsigned | Average duration of |
| | integer | an order in |
| | | milliseconds |
| initialOrderPeriodMaxMS | 32-bit unsigned | Period of time for |
| | integer | initial order setup in |
| | | milliseconds |
| averageStartTradeCount | 8-bit unsigned | Average number of |
| | integer | starting/initial orders |
| standardDeviation | 32-bit IEEE | Standard deviation of |
| | 754 float | normal distribution of |
| | | order price around |
| | | bid/ask spread, in |
| | | percent |
| newOrderThreshold | 32-bit IEEE | Threshold for |
| | 754 float | available liquidity |
| | | before generating a |
| | | new order |
| generateBuyOrders | 1-bit boolean | Whether to generate |
| | | buy orders |
| generateSellOrders | 1-bit boolean | Whether to generate |
| | | sell orders |

The following data structures are used by the order generation algorithm:

| | Order Generation Algorithm Data Structures | | |
|---|---|---|---|
| | Fields | | |
| Structure | Label | Type | Description |
| GeneratedTradeOrder | pricePercentage | IEEE 754 32-bit float | Geometry for a |
| | liquidityPercentage | IEEE 754 32-bit float | single liquidity |
| | startTimeMS | 32-bit unsigned integer | providing order |
| | durationMS | 32-bit unsigned integer | (price defined as |
| | buyOrder | 1-bit boolean | percentage from |
| | | | bid/ask, liquidity |
| | | | defined as |
| | | | percentage of |
| | | | committed |
| | | | liquidity, start time |
| | | | defined in |
| | | | milliseconds since |
| | | | round start, |
| | | | duration defined as |
| | | | milliseconds after |
| | | | start time |

### Example Algorithm

1. A Linear Congruential PRNG is instantiated with the provided seed, referred to as “ [symbol] ” for short.
2. A Gaussian Random PRNG is instantiated with the first 64-bits of randomness sourced from [symbol] and is referred to as “ [symbol] ” for short.
3. A random unsigned integer is generated from [symbol] in the interval [0, [symbol] ), is summed with [symbol] , and the result is referred to as “ [symbol] ”.
4. Local IEEE 754 32-bit float variable [symbol] is set to 1.00 f/ [symbol]
5. Local IEEE 754 32-bit float variables [symbol] and [symbol] are set to 0, and local unsigned 32-bit integer variables [symbol] and [symbol] are also set to 0.
6. Local List (of expandable size) of [symbol] structs is instantiated and referred to as “ [symbol] ”
7. A loop is executed [symbol] times, each time:
   a. A local IEEE 754 32-bit float variable [symbol] is set to the absolute value of the next gaussian float generated by [symbol] multiplied by [symbol]
   b. A local IEEE 754 32-bit float variable [symbol] [symbol] is set to [symbol] + [symbol] *0.25)* [symbol] −0.5)*2
   c. A local IEEE 754 32-bit float variable [symbol] is set to [symbol]
   d. A local IEEE 754 32-bit float variable [symbol] is set to the absolute value of [symbol] * [symbol] * [symbol]
   e. If [symbol] is greater than [symbol] then it is set to [symbol] [symbol]
   f. A local IEEE 754 32-bit float variable [symbol] is set to [symbol] [symbol] [symbol]
   g. [symbol] is set to [symbol] + [symbol]
   h. A local 32-bit unsigned integer [symbol] is set to [symbol] [symbol] [symbol]
   i. A GeneratedTradeOrder struct [symbol] is created, with [symbol] [symbol] [symbol] [symbol] [symbol]
   j. [symbol] is set to [symbol] [symbol]
   k. [symbol] is added to the list [symbol]
   l. A local IEEE 754 32-bit float variable [symbol] is set to the absolute value of the next gaussian float generated by [symbol] multiplied by [symbol]
   m. A local IEEE 754 32-bit float variable [symbol] is set to [symbol] + [symbol] *0.25)* [symbol] −0.5)*2
   n. A local IEEE 754 32-bit float variable [symbol] is set to [symbol]
   o. A local IEEE 754 32-bit float variable [symbol] is set to the absolute value of [symbol] * [symbol] * [symbol]
   p. If [symbol] is greater than [symbol] then it is set to [symbol] [symbol]
   q. A local IEEE 754 32-bit float variable [symbol] is set to [symbol] [symbol] [symbol]
   r. [symbol] is set to [symbol] [symbol]
   s. A local 32-bit unsigned integer [symbol] is set to [symbol] [symbol] [symbol]
   t. A GeneratedTradeOrder struct [symbol] is created, with [symbol] [symbol] [symbol] [symbol] [symbol] [symbol]
   u. [symbol] is set to [symbol] [symbol]
   v. [symbol] is added to the list [symbol]
8. A local List (of expandable size) of [symbol] structs is instantiated and referred to as [symbol]
9. A local List (of expandable size) of [symbol] structs is instantiated and referred to as [symbol]
10. All structs in [symbol] are moved to [symbol]
11. A local 32-bit unsigned integer variable [symbol] is set to the highest [symbol] variable of all of the structs in [symbol]
12. A loop is executed [symbol] [symbol] times, each time:
   a. A local 32-bit unsigned integer variable [symbol] is set to the [symbol] [symbol] (where [symbol] refers to how many times this loop has executed)
   b. For each struct [symbol] in [symbol]
      i. If [symbol] >= [symbol] [symbol]
         1. Move [symbol] from [symbol] to [symbol]
         2. If [symbol] is false, set [symbol] to [symbol] [symbol]
         3. Else (if [symbol] is true), set [symbol] to [symbol] [symbol]
   c. If [symbol] >= [symbol]
      i. A local IEEE 754 32-bit float variable [symbol] is set to the absolute value of the next gaussian float generated by [symbol] multiplied by [symbol]
      ii. A local IEEE 754 32-bit float variable [symbol] is set to [symbol]
      iii. A local IEEE 754 32-bit float variable [symbol] is set to [symbol]
      iv. A local IEEE 754 32-bit float variable [symbol] is set to the absolute value of [symbol] * [symbol] * [symbol]
      v. If [symbol] is greater than [symbol] then it is set to [symbol]
      vi. A local 32-bit unsigned integer [symbol] is set to [symbol] [symbol]
      vii. A local 32-bit unsigned integer [symbol] is set to [symbol]
      viii. A GeneratedTradeOrder struct [symbol] is created, with [symbol] [symbol] [symbol] [symbol] [symbol]
      ix. [symbol] is set to [symbol]
      x. [symbol] is added to the list [symbol]
   d. If [symbol] >= [symbol]
      i. A local IEEE 754 32-bit float variable [symbol] is set to the absolute value of the next gaussian float generated by [symbol] multiplied by [symbol]
      ii. A local IEEE 754 32-bit float variable [symbol] is set to [symbol]
      iii. A local IEEE 754 32-bit float variable [symbol] is set to [symbol]
      iv. A local IEEE 754 32-bit float variable [symbol] is set to the absolute value of [symbol] * [symbol] * [symbol]
      v. If [symbol] is greater than [symbol] then it is set to [symbol]
      vi. A local 32-bit unsigned integer [symbol] is set to [symbol] [symbol]
      vii. A local 32-bit unsigned integer [symbol] is set to [symbol]
      viii. A GeneratedTradeOrder struct [symbol] is created, with [symbol] [symbol] [symbol] [symbol] [symbol] [symbol]
      ix. [symbol] is set to [symbol]
      x. [symbol] is added to the list [symbol]
   e. All orders in [symbol] and [symbol] are added to [symbol]
   f. If [symbol] then remove all elements from [symbol] where [symbol]
   g. If [symbol] then remove all elements from [symbol] where [symbol]
   h. [symbol] is sorted ascending based on the [symbol] of each struct element
   i. [symbol] is returned.

The Order Generation Algorithm is used two times in the present disclosure: generating orders on a liquidity provider's computer which they then place using industry-standard software that can communicate with cryptocurrency exchanges, and regenerating orders on a verifier's computer (which may be all full-node blockchain validators on a network who all independently perform the same verification process) so that the orders a liquidity provider was supposed to place during a liquidity round can be verified by cross-referencing against orderbook data (see the Order Verification Process).

Note that even when no buy and/or sell orders are desired as outputs from the algorithm, the detailed implementation example algorithm generates these unwanted orders anyway, and then removes them prior to returning the completed list of orders, which ensures that the same buy and sell orders are generated whether either or both were requested, because the Linear Congruential and Gaussian Random PRNGs are accessed in the same pattern. This could be optimized by generating two separate pairs of each PRNG, using one pair for buy and one pair for sell orders if desired.

### Order Verification

Orders are re-generated by one or more third parties (e.g., with the event verification engine 140) using the order generation algorithm after the completion of a liquidity round. These re-generated orders are compared against historical orderbook data to verify that the liquidity provider successfully placed the prescribed orders at the correct times and left them up for a sufficient duration.

For example, one party agrees to create a given amount of liquidity on a particular market in exchange for consideration from another party. Both parties are distrustful, so they collaborate on selecting a seed which neither party can influence, the liquidity provider uses the secure seed to generate orders, and places those orders on the orderbook. At the end, the liquidity provider reveals their portion of the secret seed, and a coordinator regenerates the orders that the liquidity provider should have placed, and verifies that they were correctly placed before releasing the consideration. If the order verification fails, the consideration is refunded to the liquidity subscriber.

In some embodiments, to verify orders, a party combines all portions of the random seed agreement to recreate the original seed used by the liquidity provider, re-runs the deterministic order generation algorithm, and then compares the regenerated orders with historic market data, ensuring that each order that should have been placed at a particular time was correctly placed and left up for the prescribed duration (or filled prior to the conclusion of the order's duration).

In some embodiments, the coordinator uses the random seed to regenerate orders that a particular liquidity provider was required to place during a liquidity round and acquires historical orderbook data for the marketplace in question (ex: ETH-USD orderbook on Coinbase). This orderbook data may be acquired from a third-party provider (such as the exchange itself, or a market data collection service) or can be recorded in real-time during the liquidity round in preparation.

The recorded or otherwise acquired data can be replayed, allowing a view of the orderbook and recently executed orders throughout the period during which liquidity was supposed to be provided on the given marketplace. By looking for the placement of orders based on orderbook data which the regenerated list of orders specifies, verifying that these orders were not taken down until their duration expires unless executed trades filled or partially filled the specified liquidity-providing orders, and keeping track of the remaining liquidity available to the liquidity provider in the event of fills or partial fills for correctly interpreting future order placement.

### Detailed Implementation Example

The following parameters are passed into the order generation algorithm:

Order Generation Algorithm Parameters

| Parameter | Type | Description |
|---|---|---|
| seed | 64-bit unsigned | Seed for all |
| | integer | pseudorandom |
| | | number generation |
| roundDurationMS | 32-bit unsigned | Duration of a round |
| | integer | in milliseconds |
| averageOrderLengthMS | 32-bit unsigned | Average duration of |
| | integer | an order in |
| | | milliseconds |
| initialOrderPeriodMaxMS | 32-bit unsigned | Period of time for |
| | integer | initial order setup in |
| | | milliseconds |
| averageStartTradeCount | 8-bit unsigned | Average number of |
| | integer | starting/initial orders |
| standardDeviation | 32-bit IEEE | Standard deviation of |
| | 754 float | normal distribution of |
| | | order price around |
| | | bid/ask spread, in |
| | | percent |
| newOrderThreshold | 32-bit IEEE | Threshold for |
| | 754 float | available liquidity |
| | | before generating a |
| | | new order |
| generateBuyOrders | 1-bit boolean | Whether to generate |
| | | buy orders |
| generateSellOrders | 1-bit boolean | Whether to generate |
| | | sell orders |
| liquidityRoundStartTime | 32-bit unsigned | The start time in ms |
| | integer | of the liquidity |
| | | providing based on |
| | | real-world time |
| | | (UNIX epoch format) |
| targetExchange | 4-byte exchange | Identifies the target |
| | identifier | exchange for the |
| | | liquidity |
| targetPair | 16-byte pair | Identifies the pair on |
| | identifier | the target exchange |
| | | (ex: BTC-USD) |
| buyLiquidityQuantity | 32-bit IEEE | Liquidity committed |
| | 754 float | by the liquidity |
| | | provider on the buy |
| | | side at the start of the |
| | | liquidity round |
| sellLiquidityQuantity | 32-bit IEEE | Liquidity committed |
| | 754 float | by the liquidity |
| | | provider on the sell |
| | | side at the start of the |
| | | liquidity round |
| orderPlacementAllowanceMS | 8-bit unsigned | How many MS of |
| | integer | error are allowed for |
| | | placement of an order |
| | | to still qualify |
| orderRemovalAllowanceMS | 8-bit unsigned | How many MS of |
| | integer | error are allowed for |
| | | placement of an order |
| | | to still qualify |
| misbehaviorThreshold | 32-bit IEEE | What percent of order |
| | 754 float | placement or removal |
| | | failures are allowed |

The following data structures are used by the order generation algorithm:

| | Order Generation Algorithm Data Structures | | |
|---|---|---|---|
| | Fields | | |
| Data Structure | Label | Type | Description |
| GeneratedTradeOrder | pricePercentage | IEEE 754 32-bit float | Geometry for a |
| | liquidityPercentage | IEEE 754 32-bit float | single liquidity |
| | startTimeMS | 32-bit unsigned integer | providing order |
| | durationMS | 32-bit unsigned integer | (price defined as |
| | buyOrder | 1-bit boolean | percentage from |
| | actual OrderPrice | IEEE 754 32-bit float | bid/ask, liquidity |
| | actualOrderSize | IEEE 754 32-bit float | defined as |
| | filledOrderSize | IEEE 754 32-bit float | percentage of |
| | | | committed |
| | | | liquidity, start time |
| | | | defined in |
| | | | milliseconds since |
| | | | round start, |
| | | | duration defined as |
| | | | milliseconds after |
| | | | start time |

### Example Algorithm

1. The Order Generation Algorithm is run (passing in the appropriate parameters that were passed to this process: [symbol] [symbol] [symbol] [symbol] [symbol] [symbol] [symbol] [symbol] and the generated List of GeneratedTradeOrder structs is stored as [symbol] (Note that the struct by the same name used in this algorithm has extra fields, so assume those additional fields are all set to zero initially when returned from the Order Generation Algorithm).
2. Historical market data is acquired (either from an external data source or a local recording agent outside the scope of this disclosure) for the given [symbol] and [symbol] starting at [symbol]
3. A local IEEE 754 32-bit float variable [symbol] is set to 0
4. A local IEEE 754 32-bit float variable [symbol] is set to 0
5. A local IEEE 754 32-bit float variable [symbol] is set to 0
6. A local IEEE 754 32-bit float variable [symbol] is set to 0
7. A local List (of expandable size) of [symbol] structs is instantiated and referred to as [symbol]
8. A local List (of expandable size) of [symbol] structs is instantiated and referred to as [symbol]
9. A loop is run [symbol] [symbol] times, each time:
   a. A local 32-bit unsigned integer variable [symbol] is set to [symbol] (where [symbol] refers to how many times this loop has executed)
   b. Acquire the view of the orderbook (including recently executed trades) from the stored historical market data at [symbol] and at each integer in the interval [symbol] [symbol] [symbol] refer to these slices as [symbol] [symbol] . . . , [symbol] [symbol]
   c. A local IEEE 754 32-bit float variable [symbol] is set to the highest bid in [symbol]
   d. A local IEEE 754 32-bit float variable [symbol] is set to the lowest ask in [symbol]
   e. A local IEEE 754 32-bit float variable [symbol] is set to [symbol] [symbol]
   f. For each struct [symbol] in [symbol]
      i. If [symbol]
         1. A local IEEE 754 32-bit float variable [symbol] is set to [symbol]
         2. A local IEEE 754 32-bit float variable [symbol] is set to [symbol]
         3. If [symbol]
            a. A local IEEE 754 32-bit float variable [symbol] is set to [symbol] [symbol]
         4. Else (if [symbol]
            a. A local IEEE 754 32-bit float variable [symbol] is set to [symbol] [symbol]
         5. If [symbol] < [symbol] then [symbol] is set to [symbol]
         6. If [symbol]
            a. A local IEEE 754 32-bit float variable [symbol] is set to [symbol] [symbol] [symbol]
         7. Else (if [symbol]
            a. A local IEEE 754 32-bit float variable [symbol] is set to [symbol] [symbol] [symbol]
         8. A (sub)loop is run [symbol] times, each time:
            a. If the difference between [symbol] [symbol] and [symbol] [symbol] at the price level [symbol] in available liquidity is equivalent to [symbol] then:
            i. Set [symbol] [symbol]
            ii. Set [symbol]
            iii. Move [symbol] from [symbol] to [symbol]
            iv. If [symbol]
            1. Set [symbol] to [symbol] + [symbol]
            v. Else (if [symbol]
            1. Set [symbol] to [symbol] + [symbol]
            vi. Exit (sub)loop
   g. For each struct [symbol] in [symbol]
      i. If [symbol] [symbol]
      ii. A (sub)loop is run [symbol] times, each time:
         1. If the difference between [symbol] [symbol] and [symbol] [symbol] at the price level [symbol] in available liquidity is equivalent to [symbol] [symbol] then:
            a. If this price level change has already been seen by a previous run of this same (sub)loop as corresponding to an order then continue to the next run of the (sub)loop.
            b. Move [symbol] from [symbol] to [symbol]
            c. If [symbol]
            i. Set [symbol] to [symbol] − [symbol]
            d. Else (if [symbol] ):
            i. Set [symbol] to [symbol] − [symbol]
            e. Exit (sub)loop
      iii. A (sub)loop is run [symbol] times, each time:
         1. If an order executed between [symbol] − [symbol] and [symbol] [symbol] exists at the same price as [symbol] then record the order's size as a local IEEE 754 32-bit float variable [symbol] :
            a. If [symbol]
            i. A local IEEE 754 32-bit float variable [symbol] [symbol] [symbol] [symbol]
            ii. Set [symbol] to [symbol] [symbol]
            iii. Set [symbol] = [symbol] / [symbol] [symbol]
            b. Else (if [symbol]
            i. A local IEEE 754 32-bit float variable [symbol] [symbol] − [symbol] * [symbol]
            ii. Set [symbol] to [symbol] + [symbol]
            iii. Set [symbol] = [symbol] + [symbol] / [symbol] [symbol]
10. A local IEEE 754 32-bit float variable [symbol] is set equal to the number of elements in [symbol] plus the number of elements in [symbol]
11. A local IEEE 754 32-bit float variable [symbol] is set equal to the number of elements in [symbol]
12. A local IEEE 754 32-bit float variable [symbol] is set equal to [symbol] [symbol] [symbol]
13. If [symbol] [symbol] then the verification was successful and the liquidity was properly provided, otherwise the verification failed and the liquidity was not properly provided.

This verification process is used by one or more verifiers to regenerate the orders that a particular liquidity provider was required to place (and later remove) on a particular orderbook on a particular exchange at particular times, and then to verify that the liquidity provider correctly placed and removed their orders when they were required to, without having to have access anything but public orderbook information.

This verification process can be operated by a central coordinator (and repeated for transparency by any interested third party), or it can be embedded into a smart contract which references marketplace data provided to the smart contract by a market orderbook information oracle. In the even that multiple oracles are used, the verification process can be used for each oracle's data, and a specific threshold of successes versus failures using different oracles' data can be used for final verification approval.

This verification process is used by one or more verifiers to regenerate the orders that a particular liquidity provider was required to place (and later remove) on a particular orderbook on a particular exchange at particular time, and then to verify that the liquidity provider correctly placed and removed their orders when they were required to, without having to have access to anything but public orderbook information.

This verification process can be operated by a central coordinator (and repeated for transparency by any interested third party), or it can be embedded into a smart contract which references marketplace data provided to the smart contract by a market orderbook information oracle. In the even that multiple oracles are used, the verification process can be used for each oracle's data, and a specific threshold of successes versus failures using different oracles' data can be used for final verification approval.

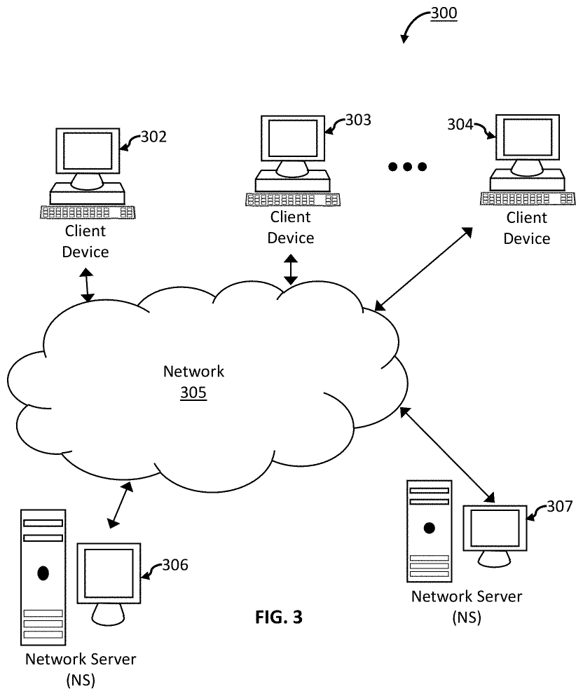

FIG. 3 depicts a block diagram of an exemplary computer-based system and platform 300 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 300 may be configured to manage a large number of members and concurrent transactions, as detailed herein. In some embodiments, the exemplary computer-based system and platform 300 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 3, member computing device 302, member computing device 303 through member computing device 304 (e.g., clients) of the exemplary computer-based system and platform 300 may include virtually any computing device capable of receiving and sending a message over a network (e.g., cloud network), such as network 305, to and from another computing device, such as servers 306 and 307, each other, and the like. In some embodiments, the member devices 302-304 may be personal computers, multiprocessor systems, microprocessor-based or programmable consumer electronics, network PCs, and the like. In some embodiments, one or more member devices within member devices 302-304 may include computing devices that typically connect using a wireless communications medium such as cell phones, smart phones, pagers, walkie talkies, radio frequency (RF) devices, infrared (IR) devices, GB-s citizens band radio, integrated devices combining one or more of the preceding devices, or virtually any mobile computing device, and the like. In some embodiments, one or more member devices within member devices 302-304 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more member devices within member devices 302-304 may run one or more applications, such as Internet browsers, mobile applications, voice calls, video games, videoconferencing, and email, among others. In some embodiments, one or more member devices within member devices 302-304 may be configured to receive and to send digital data constituting web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 302-304 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which produces data which is remotely downloadable by the user using network protocols such as FTP, SSH, or other file transfer mechanisms. In some embodiments, a member device may provide several levels of user interface, for example, advance user, standard user. In some embodiments, one or more member devices within member devices 302-304 may be specifically programmed to include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 305 may provide network access, data transport and/or other services to any computing device coupled to it. In some embodiments, the exemplary network 305 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 305 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 305 may include and implement, as an alternative or in conjunction with one or more of the above, a WiMAX architecture defined by the WiMAX forum. In some embodiments and, optionally, in combination of any embodiment described above or below, the exemplary network 305 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 305 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 305 may also include mass storage, such as network attached storage (NAS), a storage area network (SAN), a content delivery network (CDN) or other forms of computer or machine readable media.

In some embodiments, the exemplary server 306 or the exemplary server 307 may be a web server (or a series of servers) running a network operating system with optional additional presence of executable software, examples of which may include but are not limited to Apache on Linux or Microsoft IIS (Internet Information Services). In some embodiments, the exemplary server 306 or the exemplary server 307 may be used for and/or provide cloud and/or network computing. Although not shown in FIG. 3, in some embodiments, the exemplary server 306 or the exemplary server 307 may have connections to external systems like email, SMS messaging, text messaging, ad content providers, etc. Any of the features of the exemplary server 306 may be also implemented in the exemplary server 307 and vice versa.

In some embodiments, one or more of the exemplary servers 306 and 307 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the member computing devices 301-304.

In some embodiments and, optionally, in combination of any embodiment described above or below, for example, one or more exemplary computing member devices 302-304, the exemplary server 306, and/or the exemplary server 307 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

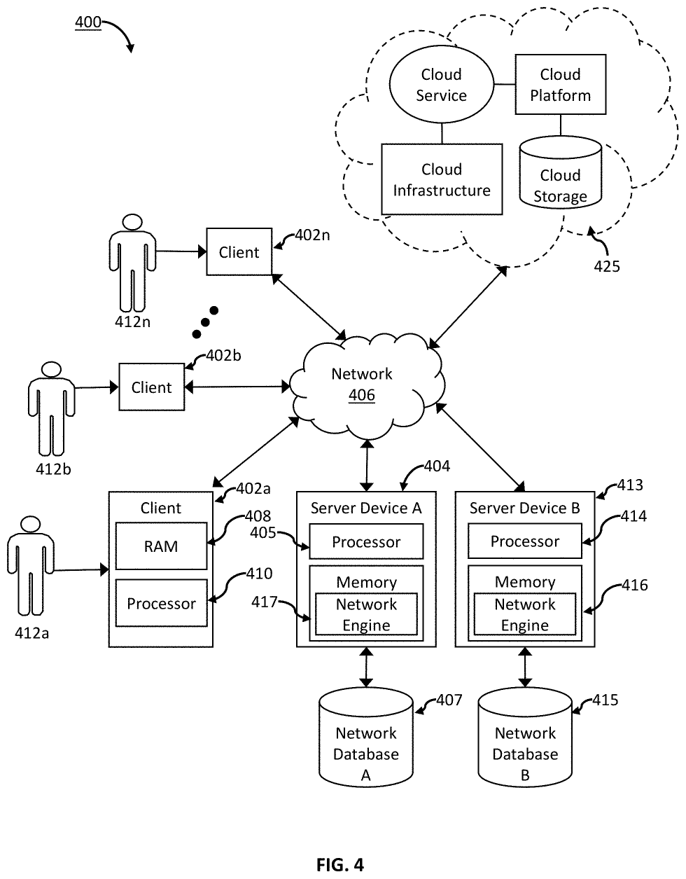

FIG. 4 depicts a block diagram of another exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 402a, member computing device 402b through member computing device 402n shown each at least includes a computer-readable medium, such as a random-access memory (RAM) 408 coupled to a processor 410 or FLASH memory. In some embodiments, the processor 410 may execute computer-executable program instructions stored in memory 408. In some embodiments, the processor 410 may include a microprocessor, an ASIC, and/or a state machine. In some embodiments, the processor 410 may include, or may be in communication with, media, for example computer-readable media, which stores instructions that, when executed by the processor 410, may cause the processor 410 to perform one or more steps described herein. In some embodiments, examples of computer-readable media may include, but are not limited to, an electronic, optical, magnetic, or other storage or transmission device capable of providing a processor, such as the processor 410 of client 402a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 402a through 402n may also comprise a number of external or internal devices such as a mouse, a CD-ROM, DVD, a physical or virtual keyboard, a display, or other input or output devices. In some embodiments, examples of member computing devices 402a through 402n (e.g., clients) may be any type of processor-based platforms that are connected to a network 406 such as, without limitation, personal computers, digital assistants, personal digital assistants, smart phones, pagers, digital tablets, laptop computers, Internet appliances, and other processor-based devices. In some embodiments, member computing devices 402a through 402n may be specifically programmed with one or more application programs in accordance with one or more principles/methodologies detailed herein. In some embodiments, member computing devices 402a through 402n may operate on any operating system capable of supporting a browser or browser-enabled application, such as Microsoft™ Windows™, and/or Linux. In some embodiments, member computing devices 402a through 402n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 402a through 402n, user 412a, user 412b through user 412n, may communicate over the exemplary network 406 with each other and/or with other systems and/or devices coupled to the network 406. As shown in FIG. 4, exemplary server devices 404 and 413 may include processor 405 and processor 414, respectively, as well as memory 417 and memory 416, respectively. In some embodiments, the server devices 404 and 413 may be also coupled to the network 406. In some embodiments, one or more member computing devices 402a through 402n may be mobile clients.

In some embodiments, at least one database of exemplary databases 407 and 415 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

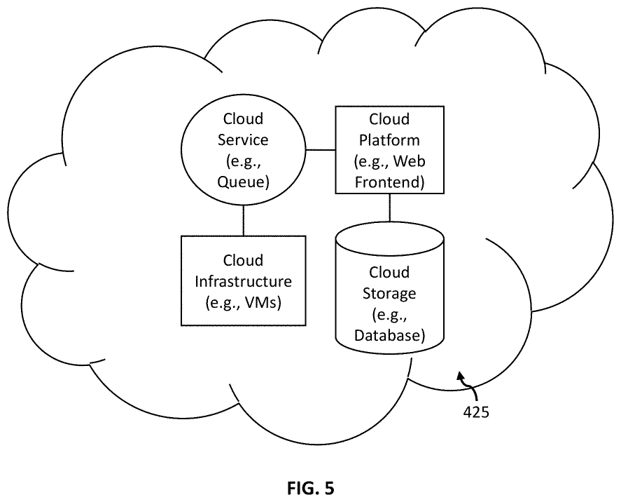

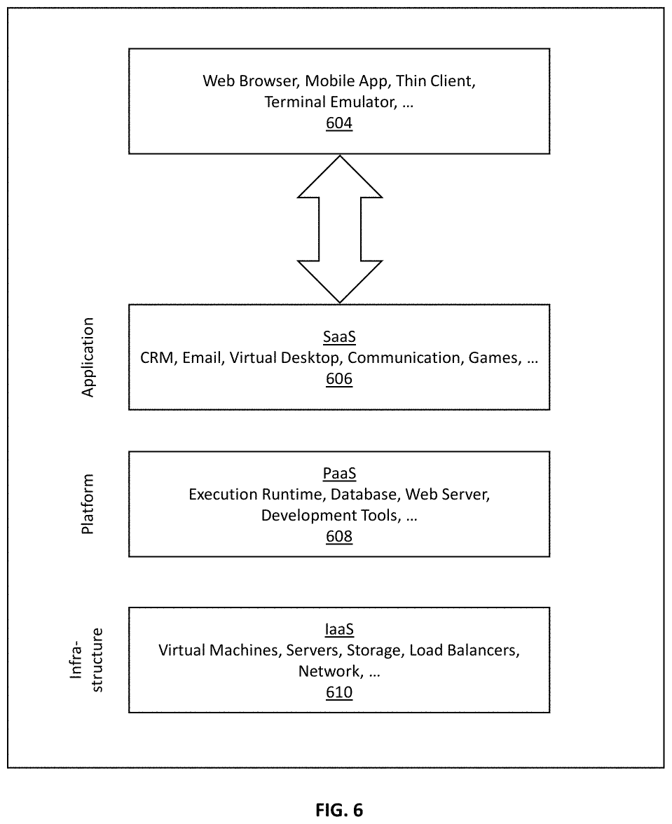

In some embodiments, the exemplary inventive computer-based systems/platforms, the exemplary inventive computer-based devices, and/or the exemplary inventive computer-based components of the present disclosure may be specifically configured to operate in a cloud computing/architecture 425 such as, but not limited to: infrastructure a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(™), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tapped” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment(s), this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) are within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array devices (FPGA), logic gates, registers, semiconductor devices, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but are not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, cryptographic identity, or the like). For example, a mobile electronic device can include, but is not limited to, a mobile phone, Personal Digital Assistant (PDA), Blackberry™, Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RCS, CAST and Skipjack), cryptographic hash algorithms (e.g., MDS, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber”, “consumer”, or “customer” should be understood to refer to a user of an application or applications as described herein and/or a consumer of data supplied by a data provider. By way of example, and not limitation, the term “user” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.

1. A method comprising:

receiving, by at least one processor, at least one event receiver request that requests at least one event between a first user on a computer platform and a second user on the computer platform, the at least one event comprising a transfer of data from the second user to the first user, and the at least one event receiver request comprising a first seed value generated by a first random number generator;

receiving, by the at least one processor, at least one event provider request for providing the at least one event between the first user and the second user, the at least one event provider request comprising a second seed value generated by a second random number generator;

instructing, by the at least one processor, at least one computing device associated with the second user to generate an event seed value based at least in part on a combination of the first seed value and the second seed value;

instructing, by the at least one processor, at least one computing device associated with the second user to utilize a pseudorandom number generator (PRNG) to generate, based on an input of the event seed value, at least one output value defining at least one parameter of the at least one event;

storing, by the at least one processor, an event entry in an event log, the event entry representing the at least one parameter of the at least one event based at least in part on the at least one output value; and executing, by the at least one processor, the transfer of data based at least in part on the event entry in the event log.

2. A system comprising:

at least one data storage that stores an event log;

at least one processor configured to execute instructions stored in a non-transitory computer readable medium, the instruction, when executed, cause the at least one processor to perform steps to:
receive at least one event receiver request that requests at least one event between a first user profile of a first user on a computer platform and a second user profile of a second user on the computer platform, the at least one event comprising a transfer of data from the second user profile to the first user profile, and the at least one event receiver request comprising a first seed value generated by a first random number generator;
receive at least one event provider request for providing the at least one event between the first user profile of the first user and the second user profile of the second user, the at least one event provider request comprising a second seed value generated by a second random number generator;
instruct at least one computing device associated with the second user profile to generate an event seed value based at least in part on a combination of the first seed value and the second seed value;
instruct at least one computing device associated with the second user profile to utilize a pseudorandom number generator (PRNG) to generate, based on an input of the event seed value, at least one output value defining at least one parameter of the at least one event;
store an event entry in an event log, the event entry representing the at least one parameter of the at least one event based at least in part on the at least one output value; and
executing the transfer of data based at least in part on the event entry in the event log.
   3. The methods and/or systems as recited in any of clauses 1 and/or 2, further comprising:

utilizing, by the at least one processor, a third random number generator to generate a third seed value for the at least one event; and

instructing, by the at least one processor, at least one computing device associated with the second user profile to generate an event seed value based at least in part on a combination of the first seed value, the second seed value and the third seed value.

4. The methods and/or systems as recited in any of clauses 1 and/or 2, further comprising:

receiving, by the at least one processor, the first seed value;

receiving, by the at least one processor, the second seed value;

generating, by the at least one processor, the event seed value based at least in part on a combination of the first seed value and the second seed value;

utilizing, by the at least one processor, a PRNG to generate, based on the event seed value, the at least one additional output value associated with the at least one event; and

validating, by the at least one processor, the event entry based at least in part on the at least one parameter of the at least one event and the at least one additional output value.

5. The methods and/or systems as recited in any of clauses 1 and/or 2 and/or 4, further comprising:

receiving, by the at least one processor, the third seed value; and

generating, by the at least one processor, the event seed value based at least in part on a combination of the first seed value, the second seed value and the third seed value.

6. The methods and/or systems as recited in any of clauses 1 and/or 2, wherein the at least one parameter comprises at least one of:

ordering of the at least one event,

size of the transfer,

price of the transfer,

placement time of the transfer, or

duration of the at least one event.

While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A method comprising:
receiving, by at least one processor, at least one event receiver request that requests at least one event between a first user on a computer platform and a second user on the computer platform, the at least one event comprising a transfer of data from the second user to the first user, and the at least one event receiver request comprising a first seed value generated by a first random number generator;
receiving, by the at least one processor, at least one event provider request for providing the at least one event between the first user and the second user, the at least one event provider request comprising a second seed value generated by a second random number generator;
instructing, by the at least one processor, at least one computing device associated with the second user to generate an event seed value based at least in part on a combination of the first seed value and the second seed value;
instructing, by the at least one processor, at least one computing device associated with the second user to utilize a pseudorandom number generator (PRNG) to generate, based on an input of the event seed value, at least one output value defining at least one parameter of the at least one event;
storing, by the at least one processor, an event entry in an event log, the event entry representing the at least one parameter of the at least one event based at least in part on the at least one output value; and
executing, by the at least one processor, the transfer of data based at least in part on the event entry in the event log.

2. The method as recited in claim 1, further comprising:
utilizing, by the at least one processor, a third random number generator to generate a third seed value for the at least one event; and
instructing, by the at least one processor, at least one computing device associated with the second user profile to generate an event seed value based at least in part on a combination of the first seed value, the second seed value and the third seed value.

3. The method as recited in claim 1, further comprising:
receiving, by the at least one processor, the first seed value;
receiving, by the at least one processor, the second seed value;
generating, by the at least one processor, the event seed value based at least in part on a combination of the first seed value and the second seed value;
utilizing, by the at least one processor, a PRNG to generate, based on the event seed value, the at least one additional output value associated with the at least one event; and
validating, by the at least one processor, the event entry based at least in part on the at least one parameter of the at least one event and the at least one additional output value.

4. The method as recited in claim 3, further comprising:
receiving, by the at least one processor, the third seed value; and
generating, by the at least one processor, the event seed value based at least in part on a combination of the first seed value, the second seed value and the third seed value.

5. The method as recited in claim 1, wherein the at least one parameter comprises at least one of:
ordering of the at least one event,
size of the transfer,
price of the transfer,
placement time of the transfer, or
duration of the at least one event.

6. A system comprising:
at least one data storage that stores an event log;
at least one processor configured to execute instructions stored in a non-transitory computer readable medium, the instruction, when executed, cause the at least one processor to perform steps to:
receive at least one event receiver request that requests at least one event between a first user profile of a first user on a computer platform and a second user profile of a second user on the computer platform, the at least one event comprising a transfer of data from the second user profile to the first user profile, and the at least one event receiver request comprising a first seed value generated by a first random number generator;
receive at least one event provider request for providing the at least one event between the first user profile of the first user and the second user profile of the second user, the at least one event provider request comprising a second seed value generated by a second random number generator;
instruct at least one computing device associated with the second user profile to generate an event seed value based at least in part on a combination of the first seed value and the second seed value;
instruct at least one computing device associated with the second user profile to utilize a pseudorandom number generator (PRNG) to generate, based on an input of the event seed value, at least one output value defining at least one parameter of the at least one event;
store an event entry in an event log, the event entry representing the at least one parameter of the at least one event based at least in part on the at least one output value; and
executing the transfer of data based at least in part on the event entry in the event log.

7. The system as recited in claim 6, wherein the instruction, when executed, further cause the at least one processor to perform steps to:
utilize a third random number generator to generate a third seed value for the at least one event; and
instruct at least one computing device associated with the second user profile to generate an event seed value based at least in part on a combination of the first seed value, the second seed value and the third seed value.

8. The system as recited in claim 6, wherein the instruction, when executed, further cause the at least one processor to perform steps to:
receive the first seed value;
receive the second seed value;
generate the event seed value based at least in part on a combination of the first seed value and the second seed value;
utilize a PRNG to generate, based on the event seed value, the at least one additional output value associated with the at least one event; and
validate the event entry based at least in part on the at least one parameter of the at least one event and the at least one additional output value.

9. The system as recited in claim 8, wherein the instruction, when executed, further cause the at least one processor to perform steps to:
receive the third seed value; and
generate the event seed value based at least in part on a combination of the first seed value, the second seed value and the third seed value.

10. The system as recited in claim 6, wherein the at least one parameter comprises at least one of:
ordering of the at least one event,
size of the transfer,
price of the transfer,
placement time of the transfer, or
duration of the at least one event.
